(19) United States
(12) Patent Application Publication
(10) Pub. No.: US 2004/0202932 A1
(43) Pub. Date: Oct. 14, 2004

(54) Electrochemically active material for an electrode

(75) Inventor: Patrick Bernard, Bordeaux (FR)

Correspondence Address: SUGHRUE, MION, ZINN,, MACPEAK & SEAS, PLLC, Suite 800, 2100 Pennsylvania Avenue, N.W., Washington, DC, 20037-3213, US

(73) Assignee: ALCATEL

(21) Appl. No.: 10/265,432

(22) Filed: Oct. 7, 2002

(30) Foreign Application Priority Data
Oct. 8, 2001 (FR) 01 12 908

(51) Int. Cl. H01M 4/32; H01M 4/52; C01G 53/04

(52) U.S. Cl. 429/223; 252/182.1; 423/594.19

(57) ABSTRACT

The invention concerns an electrochemically active material for a positive electrode of an alkaline electrolyte secondary cell, constituted by monophase particles of a hydroxide of α type crystallographic structure principally constituted by nickel, characterized in that the bulk density of said hydroxide is 1.75 g/cm³ or more. Preferably, the nickel hydroxide contains at least one co-crystallized element selected from cobalt and manganese. Also preferably, it contains at least one co-crystallized element selected from aluminum, iron, yttrium, manganese, and chromium. The present invention also concerns a positive electrode for an alkaline electrolyte secondary cell containing this electrochemically active material. The present invention also concerns a method of producing said active material.

The present invention relates to an electrochemically active material for a paste or plasticized electrode, in particular for a positive nickel-based electrode for an alkaline electrolyte secondary electrochemical cell. More precisely, the present invention relates to an electrochemically active material constituted by a nickel hydroxide with an α type (α—Ni (OH)₂) crystallographic structure.

A paste or plasticized electrode is composed of a support acting as a current collector on which a paste containing the electrochemically active material and a binder are coated and to which a conductive material is usually added. It is traditionally produced by depositing the paste onto a two-dimensional conductive support (plasticized type) or, more frequently, into a porous three-dimensional conductive support (paste type) such as a metal or carbon felt or foam.

In the case of a nickel hydroxide-based electrode, structural modifications occurring during cycling have been explained by BODE et al. (Electrochemica Acta, 11 (1966) 1079) in the form of a diagram involving the α^{II}, β^{II, β}^{III} and γ^{III} phases the structure of which are well known in crystallographic circles:

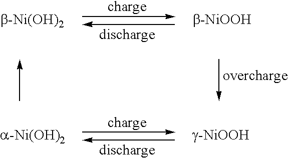

In all batteries that are currently on the market, the nickel hydroxide used, usually in the form of spherical particles, is a nickel hydroxide with a β type (β—Ni (OH)₂) crystallographic structure which is mainly transformed into the oxyhydroxide β—NiOOH by simple deprotonation when charging the electrode. The nickel hydroxide can contain a minor proportion of a hydroxide of one or more other co-crystallized metals which do not modify the crystalline structure. German patent DE-A-4 429 273 describes a β—Ni (OH)₂ type nickel hydroxide containing co-crystallized zinc and cobalt.

Since nickel hydroxide is a poor conductor, it is normally associated with a conductive material such as a cobalt compound, for example cobalt metal, a cobalt hydroxide and/or a cobalt oxide. As an example, United States patent U.S. Pat. No. 6 040 007 describes a method of producing a high density spherical nickel hydroxide. The active material of the positive electrode is a nickel hydroxide coated with cobalt hydroxide. When the nickel hydroxide is coated with a type cobalt hydroxide, the bulk density of the active material is at least 1.6 grams per cubic centimeter (g/cm³). When the nickel hydroxide is coated with β type cobalt hydroxide, the bulk density of the active material is at least 1.9 g/cm³. The specific surface area of the active material is less than 0.5 squaremeters per gram (m²/g)

The α—Ni(OH)₂ phase, which can be obtained by cathodic deposition or by any other method, has the advantage of possessing much higher conductivity than the β—Ni(OH)₂ phase. However, it spontaneously transforms itself into β—Ni(OH)₂ in an alkaline aqueous medium. Thus, its chemical composition has to be modified to stabilize it by adding dopants such as aluminum, iron, cobalt, yttrium, chromium, or manganese.

As an example, European patent EP-A-0 952 621 describes an active material for an alkaline secondary cell constituted by an a type nickel hydroxide containing 8 to 60 mole % of manganese.

EP-A-0 975 036 discloses an active material for the positive electrode of a sealed alkaline secondary cell constituted by a nickel oxyhydroxide including manganese in solid solution in which the amount of γ—NiOOH phase is 65% to 100% and that of the α—Ni(OH)₂ phase is 40% to 0%, measured by the ratio of the X ray diffraction peaks.

EP-A-0 1 027 742 describes an active material based on an a phase nickel hydroxide of formula:

[(Ni²⁺) [_{1-x-y}](A^{m+})ₓBⁿ⁺)y(OH⁻)2]

in which A can be cobalt or manganese, and B can be yttrium.

The aim of the invention is to increase both the mass energy density and the volume energy density simultaneously of an electrode in which the electrochemically active material is a hydroxide principally constituted by nickel.

Thus, the invention provides an electrochemically active material for a positive electrode of an alkaline electrolyte secondary cell, constituted by monophase particles of a hydroxide with an a type crystallographic structure principally constituted by nickel, characterized in that the bulk density of said hydroxide is 1.75 g/cm³ or more.

Throughout the present text, the term “bulk density” is measured using the method known as the tapped bulk density method the conditions of which are defined in American standard ASTM-B257.

Clearly, the term “hydroxide principally containing nickel” as used in the present application can mean a nickel hydroxide, but also a nickel hydroxide also containing a small proportion of at least one co-crystallized hydroxide of another element. A co-crystallized hydroxide contained in the nickel hydroxide is a hydroxide forming a solid solution with the nickel hydroxide, i.e., occupying, in a continuously variable proportion, the atomic sites defined by the crystal lattice of the nickel hydroxide. The hydroxide obtained comprises a single crystalline phase.

In a preferred embodiment, the hydroxide principally containing nickel also contains a minor proportion of a co-crystallized hydroxide of at least one other element.

In a first variation, the hydroxide principally containing nickel also contains a minor proportion of a first co-crystallized hydroxide of at least one element selected from cobalt Co and manganese Mn.

In a second variation, the hydroxide principally containing nickel also contains a minor proportion of a second co-crystallized hydroxide of at least one element selected from aluminum Al, iron Fe, yttrium Y, manganese Mn and chromium Cr.

Preferably, the total proportion of said co-crystallized elements with respect to the nickel is less than 30% by weight, preferably in the range 13% to 30% by weight.

Advantageously, the nickel hydroxide contains at least one anion selected from carbonates CO₃⁼, sulfates SO₄⁼ and nitrates NO₃⁻.

Preferably, the specific surface area of the nickel hydroxide is in the range 2 m²/g to 30 m²/g.

The nickel-based hydroxide with the a crystalline structure of the invention is prepared by precipitating at least one nickel salt in a highly concentrated alkaline and/or ammoniacal solution.

Preferably, said alkaline and/or ammoniacal solution is at a temperature that is above ambient temperature.

When a nickel-based hydroxide containing co-crystallized doping elements is used, a mixture of a nickel salt and salts of the elements to be co-crystallized is used. In this variation, at least one salt of an element selected from cobalt and manganese, and at least one salt of an element selected from aluminum, iron, yttrium, manganese, and chromium on the other hand are precipitated simultaneously with said nickel salt.

Advantageously, said salt in an aqueous solution.

Preferably, said salt is selected from carbonates, sulfates and nitrates, and more preferably said salt is a sulfate.

In a particular implementation, said salt solution also contains an oxidizing agent.

The invention also provides a positive electrode for an alkaline electrolyte secondary cell having an electrochemically active material which is principally constituted by a hydroxide principally containing nickel with an a type crystallographic structure with a bulk density of 1.75 g/cm³ or more.

The invention also provides a method of producing an active material, comprising precipitating at least one nickel salt in a highly concentrated alkaline and/or ammoniacal solution at a temperature that is higher than ambient temperature.

In a first variation, simultaneously with the nickel salt, at least a first salt of at least one other element selected from cobalt and manganese is precipitated.

In a second variation, simultaneously with the nickel salt, a second salt of at least one other element selected from aluminum, iron, yttrium, manganese and chromium is precipitated.

Preferably, the salt is in an aqueous solution.

Preferably again, the salt is selected from carbonates, sulfates and nitrates.

The salt solution may also contain an oxidizing agent.

### EXAMPLE 1

An active material in accordance with the present invention was produced as follows. An aqueous solution of a mixture of nickel sulfate, cobalt sulfate and aluminum sulfate was produced to which an oxidizing agent, for example H₂O₂, was added. Further, a concentrated solution of a mixture of potassium hydroxide KOH, potassium carbonate K₂CO₃, and ammonia was heated and stirred. The aqueous salt solution was added. The precipitate obtained was then washed, filtered, and vacuum dried for 24 hours at 50° C. A nickel-based hydroxide was obtained with an a type crystallographic structure containing cobalt and aluminum.

A positive electrode A in accordance with the invention was produced with a paste having the following composition by weight (expressed as a % with respect to the weight of the paste):

| | |
|---|---|
| electrochemically active material | 92.7% |
| cobalt oxide CoO conductive material | 8% |
| PTFE binder | 1% |
| HPMC thickening agent | 0.3% |

The powdered electrochemically active material was constituted by a nickel-based hydroxide with an α type structure co-crystallized with 15% of aluminum and 6% of cobalt, and with a bulk density of 1.77 g/cm³. The powdered electrochemically active material contained carbonate anions. Its developed surface area was 10 m²/g. The binder was polytetrafluoroethylene (PTFE). The thickening agent was the sodium salt of hydroxypropyl-methylcellulose (HPMC). The viscosity of the paste was adjusted with water. The paste was introduced into the conductive support acting as a current collector which was a nickel foam with porosity of about 95%. Once the paste had been introduced into the support, the entire assembly was dried to eliminate waster, and then laminated to obtain an electrode with the desired thickness.

### EXAMPLE 2

A positive electrode B was produced with a paste having the following composition by weight (expressed as a % with respect to the weight of the paste):

| | |
|---|---|
| electrochemically active material | 92.7% |
| cobalt oxide CoO conductive material | 8% |
| PTFE binder | 1% |
| HPMC thickening agent | 0.3% |

The powdered electrochemically active material was constituted by a nickel-based hydroxide with a β type crystalline structure co-crystallized with 2% of cobalt and 3% of zinc. The binder was polytetrafluoroethylene (PTFE). The thickening agent was the sodium salt of hydroxypropylmethylcellulose (HPMC). The viscosity of the paste was adjusted with water. The paste was introduced into the conductive support acting as a current collector which was a nickel foam with porosity of about 95%. Once the paste had been introduced into the support, the entire assembly was dried to eliminate waster and then laminated to obtain an electrode with the desired thickness.

### EXAMPLE 3

A positive electrode C was produced with a paste having the following composition by weight (expressed as a % with respect to the weight of the paste):

| | |
|---|---|
| electrochemically active material | 92.7% |
| cobalt oxide CoO conductive material | 8% |
| PTFE binder | 1% |
| HPMC thickening agent | 0.3% |

The powdered electrochemically active material was constituted by a nickel-based hydroxide with an α type structure co-crystallized with 17% of aluminum and 5% of cobalt, and with a bulk density of 1.34 g/cm³. The powdered electrochemically active material contained carbonate anions. Its developed surface area was 48 m²/g. The binder was polytetrafluoroethylene (PTFE). The thickening agent was the sodium salt of hydroxypropylmethylcellulose (HPMC). The viscosity of the paste was adjusted with water. The paste was introduced into the conductive support acting as a current collector which was a nickel foam with porosity of about 95%. Once the paste had been introduced into the support, the entire assembly was dried to eliminate waster, and then laminated to obtain an electrode with the desired thickness.

A comparative energy density test is described below. In this test, the embodiment of the invention (cell A) was compared with a prior art reference electrode in which the powdered electrochemically active material was constituted by a nickel-based hydroxide with β type structure (cell B), and a comparative electrode the electrochemically active material of which was constituted by nickel with α type structure with a bulk density of 1.75 g/cm³ or less (cell C)

A cylindrical sealed cylindrical nickel-metal hydride Ni-MH secondary cell of A format (standard CEI 285) with a nominal capacity Cn of 1500 mAh was produced as follows. The negative electrode, of known type, had an intermetallic compound that was capable of forming a hydride MH once charged as the electrochemically active material. Its capacity was greater than that of the positive electrode. Each positive electrode was alongside a negative electrode from which it was insulated by a separator constituted by a nonwoven polypropylene sheet to form the electrochemical stack. The spiral wound stack was inserted into a metal can and impregnated with an alkaline electrolyte which was an aqueous alkaline solution constituted by a mixture of 7.5 N potassium hydroxide KOH, 0.5 N lithium hydroxide LiOH and 0.4 N sodium hydroxide NaOH. Secondary cells A, B and C were produced as described.

After 48 hours's rest, the cells underwent electrical forming under the following conditions:

Rest for 2 hours at a temperature of 80° C. Cycle 1:

charge at a rate of 0.1 Ic for 8 hours at 80° C., where Ic is the current necessary to discharge the nominal capacity C of the cell in 1 hour;

rest for 4 hours at 20° C.;

charge for 3 hours at a rate of 0.33 Ic;

discharge at a rate of 0.66 Ic for 1 hour;

charge for 1 hour at a rate of Ic and 1 hour 12 minutes at a rate of 0.5 Ic;

discharge at a rate of 0.2 Ic to a cut-off voltage of 0.9 volts;

Cycles 2 to 10:

charge at a rate of 0.1 Ic for 16 hours at 20° C.;

discharge at a rate of 0.2 Ic to a cut-off voltage of 0.9 volts.

The electrical performance of cells A, B, and C are summarized in Table 1 below:

TABLE 1

| | Cell | | |
|---|---|---|---|
| | A | B | C |
| Volume energy density of positive | 274 | 255 | 323 |
| electrode at cycle 10 (mAh/g) | | | |
| Mass energy density of positive | 669 | 655 | 526 |
| electrode at cycle 10 (mAh/cm³) | | | |

These results show that cell A of the invention performs better than the cell with reference B both in terms of volume energy density (+2.1%) and mass energy density (+7.5%). Further, its volume energy density is far superior to that of cell C (+27.2%). Cell C has an improved mass energy density compared with that of cell B (+26.7%), but its volume energy density is lower (−19.7%).

1. An electrochemically active material for a positive electrode of an alkaline electrolyte secondary cell, constituted by monophase particles of a hydroxide of α type crystallographic structure principally containing nickel, characterized in that the bulk density of said hydroxide of a type structure is 1.75g/cm³ or more.

2. An active material according to claim 1, in which the hydroxide principally containing nickel also contains a minor proportion of a co-crystallized hydroxide of at least one other element.

3. An active material according to claim 2, in which the hydroxide principally containing nickel also contains a minor proportion of a first co-crystallized hydroxide of at least one element selected from cobalt and manganese.

4. An active material according to claim 2 or claim 3, in which the hydroxide principally containing nickel also contains a minor proportion of a second co-crystallized hydroxide of at least one element selected from aluminum, iron, yttrium, manganese, and chromium.

5. An active material according to one of claims 2 to 4, in which the total proportion of said co-crystallized elements is in the range 13% to 30% by weight with respect to the nickel.

6. An active material according to one of the preceding claims, in which the hydroxide principally containing nickel contains at least one anion selected from carbonates, sulfates, and nitrates.

7. An active material according to one of the preceding claims, in which the specific surface area of the hydroxide principally containing nickel is in the range 2 m²/g to 30 m²/g.

8. A positive electrode for an alkaline electrolyte secondary cell containing an electrochemically active material according to any one of the preceding claims.

9. A method of producing an active material according to one of claims 1 to 7, comprising precipitating at least one nickel salt in a highly concentrated alkaline and/or ammoniacal solution at a temperature that is higher than ambient temperature.

10. A method according to claim 9, in which a first salt of at least one other element selected from cobalt and manganese is precipitated simultaneously with said nickel salt.

11. A method according to claim 9 or claim 10, in which a second salt of at least one other element selected from aluminum, iron, yttrium, manganese, and chromium is precipitated simultaneously with said nickel salt.

12. A method according to one of claims 9 to 11, in which said salt is in aqueous solution.

13. A method according to one of claims 9 to 12, in which said salt is selected from carbonates, sulfates and nitrates.

14. A method according to one of claims 9 to 13, in which said salt solution also contains an oxidizing agent.
